(19) United States
(12) Patent Application Publication
(10) Pub. No.: US 2017/0000095 A1
(43) Pub. Date: Jan. 5, 2017

(54) Multi-Purpose Fishing Lure, Lure Assembly and Method for Using the Multi-Purpose Fishing Lure

(71) Applicant: Zun-Yuan Huang, New Taipei City (TW)

(72) Inventor: Zun-Yuan Huang, New Taipei City (TW)

(21) Appl. No.: 14/955,092

(22) Filed: Dec. 1, 2015

(30) Foreign Application Priority Data
Jun. 30, 2015 (TW) 104210547

(51) Int. Cl. A01K 85/01; A01K 85/02

(52) U.S. Cl. CPC A01K 85/01; A01K 85/02

(57) ABSTRACT

A multi-purpose fishing lure, lure assembly and method for using the multi-purpose fishing lure are disclosed. The multi-purpose fishing lure has a main body and a first notch, wherein the first notch is disposed on the main body.

### BACKGROUND OF THE INVENTION

1. Field of the Invention

The present invention relates to a multi-purpose fishing lure, and more particularly to a multi-purpose fishing lure that can serve as a fishing lure, a bait feed, or an artificial bait.

2. Description of the Related Art

Fishing bait is usually made of fish, shrimp or worms and needs to be preserved properly; i.e., it needs to be stored at low temperatures to prevent decomposition. Furthermore, such kinds of fishing bait need to be kneaded into a proper shape before being hung on a fishing hook by the user. During the shaping process, the flesh of the fish or shrimp may accumulate on the user's hands and then must be washed off, which causes inconvenience to the user. Thus an improvement to fishing lure design is needed.

### SUMMARY OF THE INVENTION

It is an object of the present invention to provide a multi-purpose fishing lure capable of being used as a fishing lure, a bait feed, or an artificial bait.

It is another object to provide a method for using the above-mentioned multi-purpose fishing lure.

To achieve the abovementioned object, the multi-purpose fishing lure comprises a main body and a first notch, wherein the first notch is disposed on the main body.

According to one embodiment of the present invention, the multi-purpose fishing lure is made of a dry fishing bait or a damp fishing bait.

According to one embodiment of the present invention, the multi-purpose fishing lure comprises an accommodating space for accommodating a content made of a damp fishing bait.

The present invention further provides a method for using the above-mentioned multi-purpose fishing lure, the method comprising the following steps: providing the above-mentioned multi-purpose fishing lure; putting the multi-purpose fishing lure in water; and removing the multi-purpose fishing lure from the water and then coating it with a powder.

The present invention further provides a lure assembly, assembled of at least two of the above-mentioned multi-purpose fishing lures, wherein one of the at least two above-mentioned multi-purpose fishing lures is made of a first fishing bait and another one of the at least two above-mentioned multi-purpose fishing lures is made of a second fishing bait.

### BRIEF DESCRIPTION OF THE DRAWINGS

FIG. 1 illustrates the steps of the method for using the multi-purpose fishing lure.

FIG. 2 is a schematic drawing of the first embodiment of the multi-purpose fishing lure.

FIG. 3 is a schematic drawing of the second embodiment of the multi-purpose fishing lure.

FIG. 4 is a schematic drawing of the third embodiment of the multi-purpose fishing lure.

FIG. 5 is a schematic drawing of the fourth embodiment of the multi-purpose fishing lure.

FIG. 6 is a schematic drawing illustrating the fourth embodiment of the multi-purpose fishing lure before being combined with a character ring.

FIG. 7 is a schematic drawing illustrating the fourth embodiment of the multi-purpose fishing lure after being combined with a character ring.

FIG. 8 is a schematic drawing of the fifth embodiment of the multi-purpose fishing lure.

FIG. 9 and FIG. 10 are schematic drawings of one embodiment of the lure assembly.

FIG. 11 is a schematic drawing of the sixth embodiment of the multi-purpose fishing lure.

FIG. 12 is a schematic drawing of the seventh embodiment of the multi-purpose fishing lure.

FIG. 13 is a schematic drawing of the eighth embodiment of the multi-purpose fishing lure.

### DETAILED DESCRIPTION OF THE PREFERRED EMBODIMENT

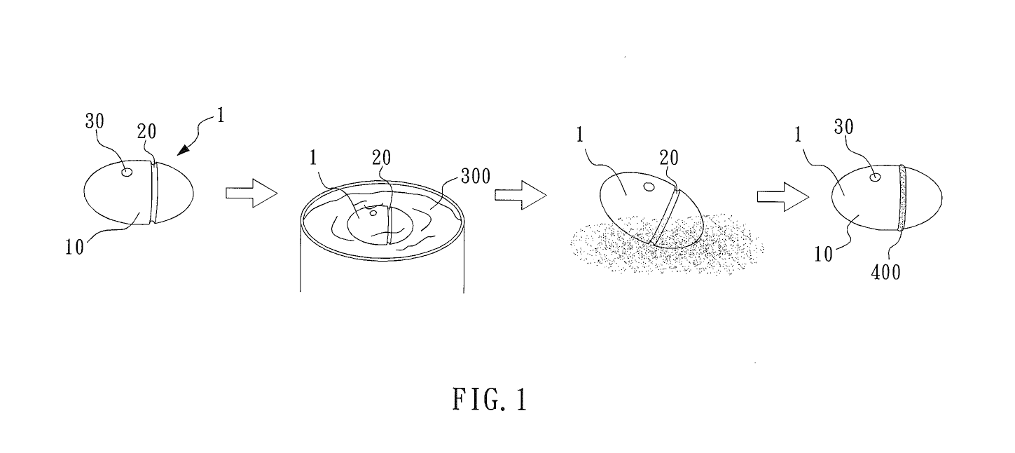

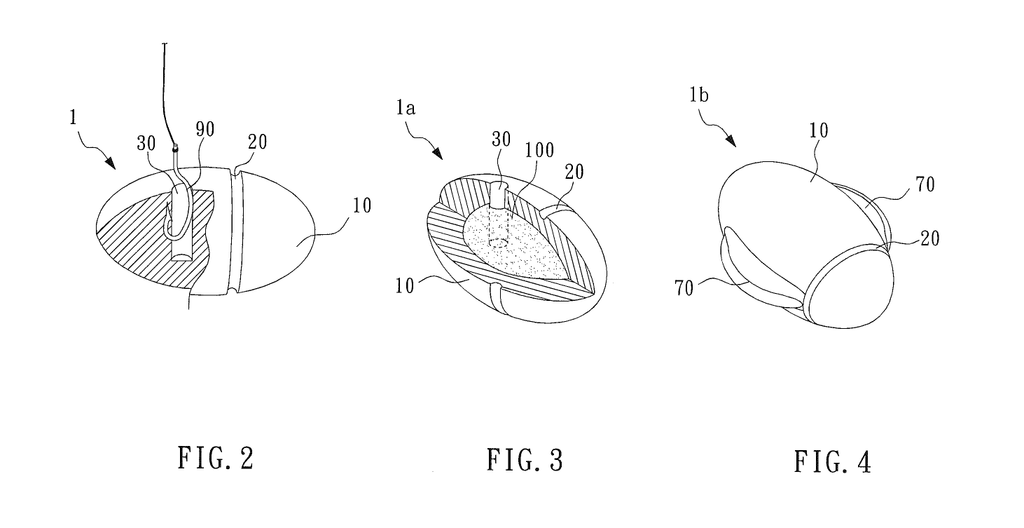

The technical content of the invention will become more apparent from the following detailed description of several preferred embodiments. Please refer to FIG. 1 and FIG. 2, which present the steps of the method for using the multi-purpose fishing lure and a schematic drawing of the first embodiment of the multi-purpose fishing lure.

As shown in FIG. 1 and FIG. 2, in the first embodiment, the multi-purpose fishing lure 1 is used as a fishing lure. The multi-purpose fishing lure 1 comprises a main body 10, a first notch 20 and a through hole 30, wherein the first notch 20 encircles the main body 10. The through hole 30 can thus be connected with a fish hook 90, and the multi-purpose fishing lure 1 is hung thereon. In the present embodiment, the multi-purpose fishing lure 1 as a whole can be made of a dry fishing bait composed of edible feed for animals, such as cereal flour, corn flour, fish bone meal, rice flour, or other flour. Therefore, the multi-purpose fishing lure 1 of the present embodiment is also bait. As shown in FIG. 1, according to one embodiment of the present invention, the method for using the multi-purpose fishing lure 1 comprises the following steps: step 1: placing the multi-purpose fishing lure 1 in water 300; step 2: removing the multi-purpose fishing lure 1 from the water 300; step 3: combining the multi-purpose fishing lure 1 with the powder 400. The surface area of the multi-purpose fishing lure 1 for contacting the water 300 and the powder 400 is increased by the first notch 20. Thus, the multi-purpose fishing lure 1 can be placed for less time in the water 300 and the quantity of the powder 400 accumulated in the first notch 20 is increased. As a result, the fishy smell of the multi-purpose fishing lure 1 is enhanced and the chance that the multi-purpose fishing lure 1 will be eaten is increased accordingly.

In the present embodiment, the powder 400 can be made of shrimp powder, fish extract powder, oyster powder, flavoring essence, artificial flavorings (such as soy sauce, gourmet powder, sugar, salt), enzymes, bait particles etc. and the size of the powder 400 can be fine grain/coarse powders or particles. Furthermore, the powder 400 can be packed in small packs and sold with the multi-purpose fishing lure 1a so that users can buy various flavors of powder 400 based on the different diets of various species. Before being hung on a fishing hook, the multi-purpose fishing lure 1 is placed in water, removed from the water, and then combined with a powder 400 for increasing the convenience of the multi-purpose fishing lure 1.

The size of the multi-purpose fishing lure 1 can be modified according to various fish species. In addition, the multi-purpose fishing lure 1 can be made of either dry fishing bait or damp fishing bait; i.e., it can be made from small fish, shrimp, crabmeat, worms, etc. Furthermore, the hardness of the multi-purpose fishing lure 1 can also be modified according to various fish species; when the multi-purpose fishing lure 1 is soft, the multi-purpose fishing lure 1 can be sold in vacuum packaging. The multi-purpose fishing lure 1 not only can be used as fishing bait but also can be pressed and then used as a bait feed.

Please refer to FIG. 3 and FIG. 4 related to the schematic drawings of the second and third embodiment of the multi-purpose fishing lure.

As shown in FIG. 3, the most distinguishable difference between the first and the second embodiments is that the multi-purpose fishing lure 1a comprises an accommodating space 40 covered by the main body 10. The content 100 is accommodated in the accommodating space 40, wherein the main body 10 is made of a dry fishing bait and the content 100 is made of a damp fishing bait. In the present embodiment, the damp fishing bait can be small fish, shrimp, crabmeat, worms, etc. As shown in FIG. 4, in the third embodiment, the multi-purpose fishing lure 1b comprises two fins 70, wherein the two fins 70 are individually disposed on opposite sides of the main body 10. With the design of the fin 70, after the multi-purpose fishing lure 1b is placed in water, the multi-purpose fishing lure 1b can flow freely in the water to better appear as a living organism to the fish. It is noted that the quantity of the fins 70 can be single or plural; it is not limited to the present embodiment.

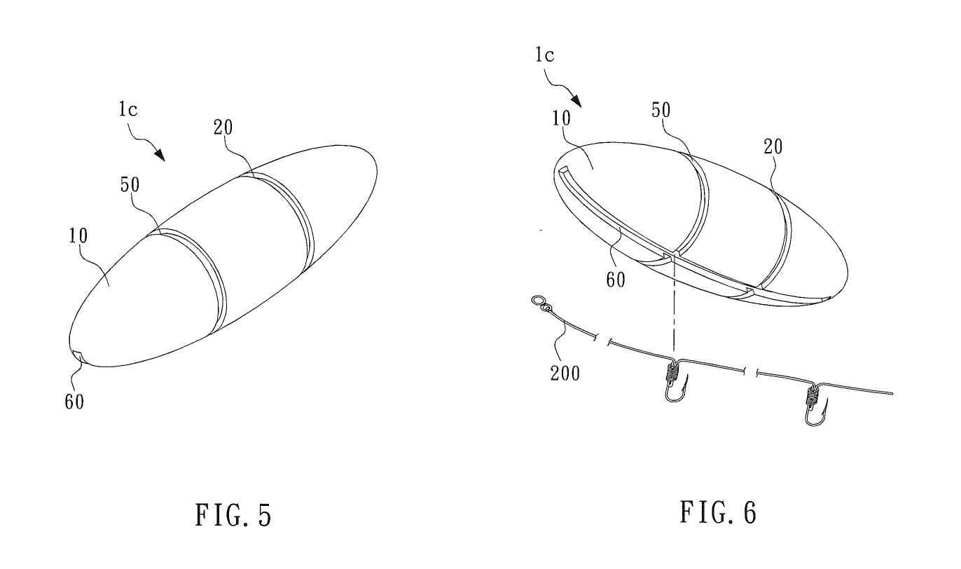

Please refer to FIG. 5 to FIG. 7, which present schematic drawings of the fourth embodiment of the multi-purpose fishing lure and the schematic drawings showing the fourth embodiment before/after being combined with a character ring.

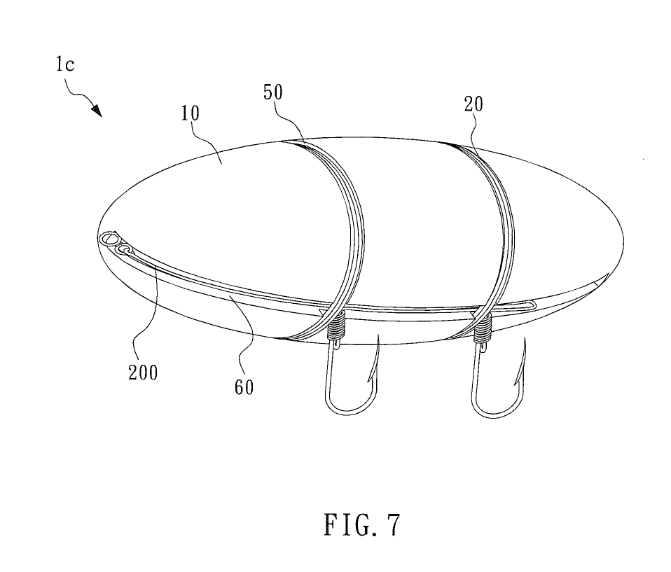

As shown in FIG. 5, in the fourth embodiment, the multi-purpose fishing lure 1c comprises a second notch 50 and a third notch 60, wherein the second notch 50 is disposed on the main body 10 and parallel to the first notch 20. As shown in FIG. 6, in the present embodiment, the first notch 20 and the second notch 50 both encircle the main body 10. The third notch 60 is disposed on the main body 10 and perpendicular to the first notch 20 and the second notch 50. As shown in FIG. 6, the multi-purpose fishing lure 1c can be combined with a character ring 200, wherein the ring 210 of the character ring 200 is disposed at an end of the third notch 60. The fishing lines 220 of the character ring 200 can be placed along the third notch 60 and encircle the first notch 20 and the second notch 50 for fixing the character ring 200 on the multi-purpose fishing lure 1c such that the state shown in FIG. 7 is achieved.

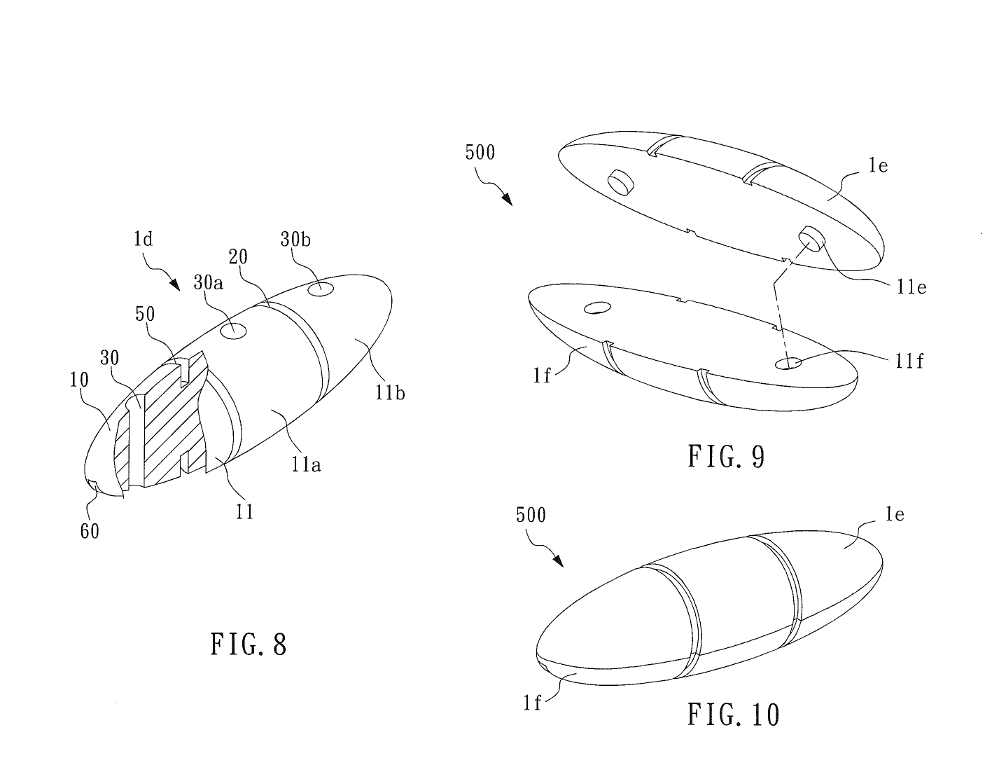

Please refer to FIG. 8 related to the schematic drawing of the fifth embodiment of the multi-purpose fishing lure. As shown in FIG. 8, in the present embodiment, the second notch 50 of the multi-purpose fishing lure 1d is disposed on the main body 10 and parallel to the first notch 20 such that on the main body 10 is divided into three sub-bodies 11, 11a, 11b and each sub-body 11, 11a, 11b has a through hole 30, 30a, 30b. Sub-bodies 11, 11a, 11b can be severed along the first notch 20 or the second notch 50 and then can be hung on a fish hook when users want to catch a fish with a small mouth. It is noted that sub-bodies 11, 11a, 11b being severable along the first notch 20 or the second notch 50 is one of the possible embodiments of the present invention. In fact, another approach is to set cutting lines on the main body 10 for severing the sub-bodies 11, 11a, 11b.

Please refer to FIG. 9 and FIG. 10, which present schematic drawings of one embodiment of the lure assembly. As shown in FIG. 9 and FIG. 10, in the present embodiment, the lure assembly 500 consists of a multi-purpose fishing lure 1e and a multi-purpose fishing lure 1f. The multi-purpose fishing lure 1e and the multi-purpose fishing lure 1f are made from different baits; i.e., dry or damp baits. As shown in FIG. 9 and FIG. 10, the multi-purpose fishing lure 1e and the multi-purpose fishing lure 1f are connected through the connecting portions 11e, 11f. In the present embodiment, the connecting portion 11e is a convex protrusion, and the connecting portion 11f is a slot matching the connecting portion 11e; however, the present invention is not limited to the present connecting method. The lure assembly 500 can also consist of multiple multi-purpose fishing lures. The multi-purpose fishing lure 1e and the multi-purpose fishing lure 1f can presented in different colors by the addition of artificial colors during production to increase the diversity of the appearance of the lure assembly 500.

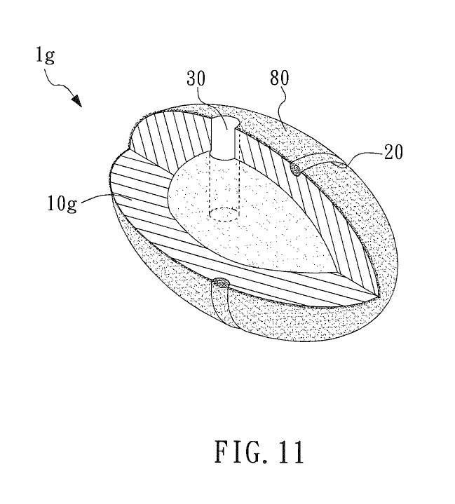

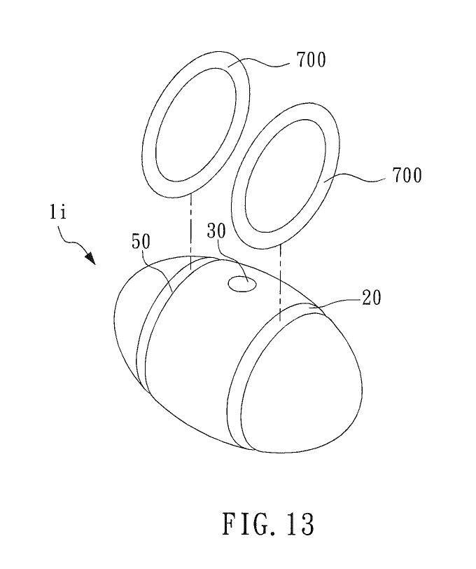

Please refer to FIG. 11 and FIG. 13 related to the schematic drawings of the sixth and seventh embodiment of the multi-purpose fishing lure.

As shown in FIG. 11, the multi-purpose fishing lure 1g further comprises a coating layer 80. In the present embodiment, the coating layer 80 is made of powder. The powder can be made of shrimp powder, fish extract powder, oyster powder, flavoring essence, artificial flavorings (such as soy sauce, gourmet powder, sugar, salt), enzymes, bait particles etc. With the design of the coating layer 80, the powder of the coating layer 80 will gradually dissolve in the water after the multi-purpose fishing lure 1g is placed in the water. As a result, the step of placing the multi-purpose fishing lure 1 in water and then coating the fishing lure 1 with powder mentioned in the first embodiment can be omitted.

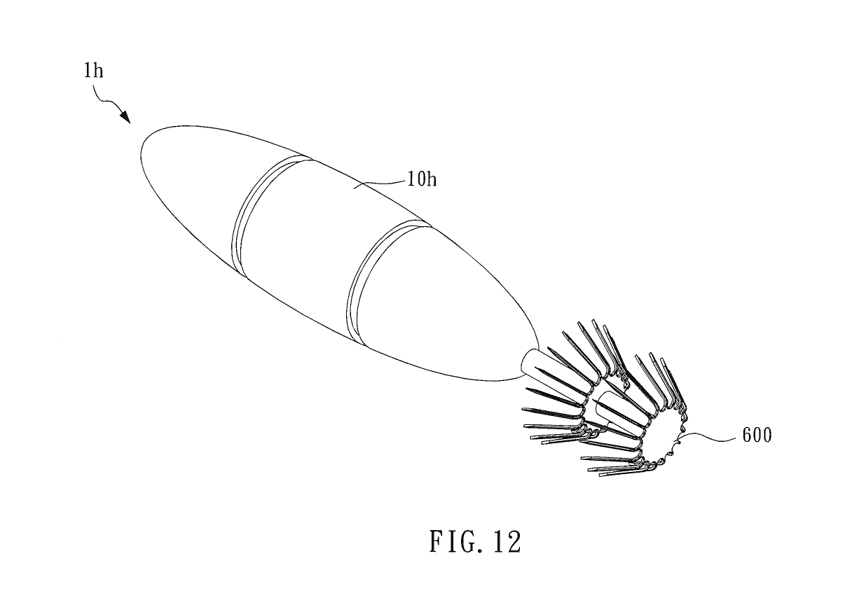

As shown in FIG. 12, the multi-purpose fishing lure 1h serves as an artificial bait. One end of the main body 10h of the multi-purpose fishing lure 1h can engage with a hook 600. The hook 600 is designed for catching squid. Because the multi-purpose fishing lure 1h is edible bait, the multi-purpose fishing lure 1h has a greater chance of being eaten than does artificial bait, such as wooden lures. As shown in FIG. 13, the multi-purpose fishing lure 1i serves as fishing bait. The second notch 50 and the first notch 20 of the multi-purpose fishing lure 1i can be individually combined with a glowing aperture 700 to increase the illumination factor of the multi-purpose fishing lure 1i. It is noted that the glowing aperture 700 is for illustration only. In fact, the illumination factor of the multi-purpose fishing lure 1i can also be increased by tying one end of a fishing line on the second notch 50 or the first notch 20 and another end of the fishing line to a light stick.

The multi-purpose fishing lures 1, 1a, 1b, 1c, 1d, 1e, 1f, 1g, 1h, 1i can serve as a fishing lure, a bait feed, or an artificial bait. According to one embodiment of the present invention, when the multi-purpose fishing lure 1 is made of a dry fishing bait, it can be preserved easily. The multi-purpose fishing lure 1 can be pressed to become bait feed whether multi-purpose fishing lure 1 is made of a dry fishing bait or a damp fishing bait. Furthermore, various flavors of the powder 400 can be employed based on the different diets of various species to increase the chance that the multi-purpose fishing lure 1 will be eaten. Moreover, according to one embodiment of the multi-purpose fishing lure 1, the inner part of the multi-purpose fishing lure 1 can include content 100 made of damp fishing bait to increase the suitability of the multi-purpose fishing lure 1.

As described above, the objectives, means, and effectiveness of the present invention differ from the characteristics of the prior art. It should be noted that the embodiments described above are for illustrating the principles and effects of the present invention, and not for limiting the scope of the present invention. Any person skilled in the art should be able to make modifications and changes to the embodiments without departing from the technical principle and spirit of the present invention. The claims of the present invention within the scope of protection are described below.

What is claimed is:

1. A multi-purpose fishing lure comprising:
a main body and a first notch, wherein the first notch is disposed on the main body.

2. The multi-purpose fishing lure as claimed in claim 1, wherein the multi-purpose fishing lure comprises a through hole for allowing a fish hook to pass through.

3. The multi-purpose fishing lure as claimed in claim 2, wherein the main body is made of a dry fishing bait or a damp fishing bait.

4. The multi-purpose fishing lure as claimed in claim 3, wherein the multi-purpose fishing lure comprises an accommodating space for accommodating a content, wherein the content is made of a damp fishing bait.

5. The multi-purpose fishing lure as claimed in claim 4, wherein at least one fin is disposed on the main body.

6. The multi-purpose fishing lure as claimed in claim 3, comprising a second notch, wherein the second notch is disposed on the main body and parallel to the first notch, the first notch and the second notch both surrounding the main body.

7. The multi-purpose fishing lure as claimed in claim 6, comprising a third notch, wherein the third notch is disposed on the main body and perpendicular to the first notch and the second notch.

8. The multi-purpose fishing lure as claimed in claim 3, comprising a coating layer for covering the main body.

9. The multi-purpose fishing lure as claimed in claim 1, wherein the main body is made of a dry fishing bait or a damp fishing bait.

10. The multi-purpose fishing lure as claimed in claim 9, the multi-purpose fishing lure comprising an accommodating space for accommodating a content, wherein the content is made of a damp fishing bait.

11. The multi-purpose fishing lure as claimed in claim 10, comprising at least one fin disposed on the main body.

12. The multi-purpose fishing lure as claimed in claim 9, comprising a second notch, wherein the second notch is disposed on the main body and parallel to the first notch, the first notch and the second notch both surrounding the main body.

13. The multi-purpose fishing lure as claimed in claim 12, comprising a third notch, wherein the third notch is disposed on the main body and perpendicular to the first notch and the second notch.

14. The multi-purpose fishing lure as claimed in claim 9, comprising a coating layer for covering the main body.

15. A lure assembly assembled of at least two multi-purpose fishing lures as claimed in claim 1, wherein one of the at least two multi-purpose fishing lures as claimed in claim 1 is made of a first fishing bait, and another one of the at least two multi-purpose fishing lures as claimed in claim 1 is made of a second fishing bait.

16. A method for using the multi-purpose fishing lure comprising the following steps:
providing a multi-purpose fishing lure as claimed in claim 1;
putting the multi-purpose fishing lure in water; and
removing the multi-purpose fishing lure from the water and then coating the multi-purpose fishing lure with a powder.
